(19) United States
(12) Patent Application Publication
(10) Pub. No.: US 2005/0266165 A1
(43) Pub. Date: Dec. 1, 2005

(54) Method for metallizing plastic surfaces

(75) Inventors: Andreas Mobius, Kaarst (DE); Jurgen Hupe, Langenfeld (DE)

Correspondence Address: SENNIGER POWERS LEAVITT AND ROEDEL, ONE METROPOLITAN SQUARE, 16TH FLOOR, ST LOUIS, MO, 63102, US

(73) Assignee: Enthone Inc., West Haven, CT (US)

(21) Appl. No.: 11/140,652

(22) Filed: May 27, 2005

(30) Foreign Application Priority Data
May 27, 2004 (DE) 10 2004 026 489.9

(51) Int. Cl. B05D 3/10; B05D 1/18

(52) U.S. Cl. 427/304; 427/437

(57) ABSTRACT

A method for metallizing plastic surfaces in which sulfides or polysulfides of activator metal are reduced to metal. This results in a conductive layer on which a metal layer can then be directly electrolytically deposited.

### FIELD OF THE INVENTION

This invention concerns a method for metallizing plastic surfaces, where the plastic surfaces are etched, activated, and then electroplated.

### REFERENCE TO RELATED APPLICATION

This application claims priority from German application number 10 2004 026 489.9, filed May 27, 2004.

### BACKGROUND OF THE INVENTION

Methods for direct metallization of plastic surfaces are known from the prior art. They serve to give the relevant plastic particular usage-specific properties. For example, plastic surfaces are metallized to produce a decorative appearance. In the electronics industry, plastic substrates are provided with metallic conductive strips and contacts in the course of a metallization in the manufacturing of integrated circuits.

In the known methods, the plastic surface is first etched to roughen it or chemically modify it. This can take place, for example, by means of mineral acids, chromic acid, chromosulfuric acid, or acid or alkaline permanganate solutions. Other pretreatment methods that are known from the prior art include plasma treatment or treatment with oxidizing etching agents.

During the etching operation, the plastic surface becomes roughened or chemically modified so that adhesion between the plastic and the metal coating is enabled. The etched plastic parts are rinsed and then activated. In the prior art there are various methods known for activation of the plastic surfaces. For example, activating the plastic surfaces with noble metals such as colloidal palladium, ionic palladium or silver colloids is known. Moreover, the use of metals that form sparingly soluble sulfides and polysulfides as activators for direct metallizing is known. In particular, tin, lead, silver, bismuth, cobalt, manganese and copper have proven to be suitable here.

The activation is followed either by a currentless metallizing of the surface to form a conductive layer followed by a subsequent electrolytic layer formation, or by direct chemical metal deposition. If palladium activation is used, this metal deposition usually takes place from an acid copper bath, while if sulfide or polysulfide activators are used, metal is deposited from a nickel bath.

For example, EP 1 001 052 B1 discloses a method for metallizing plastic surfaces in which the process steps of etching treatment of the plastic surface, activation of the etched plastic surface, treatment of the activated plastic surface with a sulfide solution, and subsequent metallization of the plastic surface that is to be treated, take place in succession. However, the first deposition of metal is possible only from an electrolyte that has a negative deposition potential such as nickel.

Surface metallization of a large number of types of plastic is possible with the methods just described. Thus, besides acrylonitrile-butadiene-styrene (ABS) plastics, it is also possible to metallize other plastics such as polyacetates, polysulfones, polycarbonates, polystyrenes, polyamides, polypropylenes or polyvinyl oxides and their blends.

One disadvantage of the generic metallization methods known from the prior art is that prior to an electrolytic metallization, a conductive layer must be chemically deposited on the substrate. This represents an additional, and as a rule costly, process step. A direct metallization is possible with the methods known from the prior art only for ABS plastics and using palladium activators.

### SUMMARY OF THE INVENTION

Taking all of this into account, this invention is based on the task of making available a method for direct electrolytic metallization of a large number of plastics that is suitable for overcoming the disadvantages of the methods known from the prior art.

This task is solved in accordance with the invention by a method for producing plastic surfaces that consists of the following steps:

etching treatment of a plastic surface;

bringing the plastic surface into contact with a metal salt and/or metal complex solution containing at least one metal salt and/or metal complex of a metal from the group consisting of cobalt, silver, tin, lead, bismuth, palladium, copper, nickel, gold, manganese, zinc, and iron; or from a subgroup of non-noble metals selected from among cobalt, tin, lead, bismuth, copper, nickel, manganese, zinc, and iron;

bringing the treated plastic surface into contact with a sulfide solution to form metal sulfide complexes on the surface, and

metallizing the treated plastic surface in a metallizing bath,

which is characterized by the fact that the sparingly soluble metal sulfides on the surface of the plastic are reduced to metal in a reduction step before the metallizing step.

Briefly, therefore, the invention is directed to a method for metallizing a plastic surface of a substrate comprising contacting the surface with a source of activator metal comprising an activator metal; contacting the surface with a sulfide solution to form metallic sulfides of the activator metal on the surface; reducing a quantity of the metallic sulfides on the surface from metallic sulfides to electrically conductive metal; and metallizing the surface in a metallizing bath to deposit metal over the electrically conductive metal reduced from the metal sulfides.

Other objects and features will be in part apparent and in part pointed out hereinafter.

### DETAILED DESCRIPTION OF THE PREFERRED EMBODIMENTS

This application claims priority from German application number 10 2004 026 489.9, the entire disclosure of which is expressly incorporated by reference.

Through the reduction of the metals present on the plastic surface in the form of sulfide complexes, one directly obtains a conductive metal layer which can be electrolytically metallized directly without the metallizing of an additional conductive layer onto the plastic surface.

Cobalt, silver, tin, bismuth and lead proved to be particularly suitable activator metals. However, the method is also suitable for all of the other activator metals that are known from the literature.

The activator metals are provided in the form of a source of activator metal which is, e.g., in the form of their salts (for example, their sulfates, nitrates, chlorides, methanesulfonates or acetates) or their complexes (for example, amino, oxo, boro, oxalate, aquo or mixed complexes).

Sodium sulfide, ammonium sulfide or ammonium polysulfide in particular are suitable as sulfur-containing compounds for preparation of sulfide (or polysulfide) complexes on the plastic surface, but all other compounds that form sulfide complexes of the said metals or metal salts and metal complexes can also be used in accordance with the invention.

The activator metals in a preferred embodiment are deposited on a nanoscale. In this connection, nanoscale means that the sulfide complexes deposited on the plastic surface have a size of 0.5-500 nm, preferably 5-100 nm. The starting point here can be a nanoscale metal complex solution. In another embodiment, the reaction conditions between the metal salt solution and sulfide solution are established so that nanoscale metal sulfides are obtained. In the context of this description, “metal sulfides” and “metallic sulfides” encompass both sulfides and polysulfide species.

The reduction of the thus obtained nanoscale metal sulfides leads to deposition of nanoscale amorphous metals as the first conductive layer on the plastic surface.

Sodium hypophosphite, dimethylamino borate, hydrazines, hydrazine hydrate, hydroxylammonium sulfates, sulfites or formates, for example, are suitable as reducing agents for reduction of the activator metal sulfide complexes in accordance with the invention.

An electrochemical reduction of the metals in the sulfide complexes is also possible in accordance with the invention. This electrochemical reduction advantageously takes place in a base electrolyte that does not contain depositable metals. One such base electrolyte is, for example, a weakly acidic sodium sulfate solution in the pH range from 1-7. An external source of electrons is applied via an electrode and the electrolyte.

The chemically or electrochemically reduced activator metal thus forms a conductive metal layer on the plastic surface that can be directly metallized without the additional metallization of an auxiliary layer, and in addition to nickel, copper can also be deposited.

An etching solution that is suitable in accordance with the invention can be, for example, a mixture of 400 g/L chromic acid and 400 g/L sulfuric acid. Moreover, a mixture in the ratio of 10-50 g/L chromic acid to 1000 g/L sulfuric acid can also be used as the etching solution in accordance with the invention. Mixtures of 0-100 g/L chromic acid to 500 g/L methanesulfonic acid can also be used as etching solutions in accordance with the invention.

The following example illustrates the method in accordance with the invention, but without limiting the invention to this embodiment example.

### EXAMPLE 1

Polyacetate (PA) and Polycarbonate (PC) Plastics

The plastic surface to be metallized is treated with a classic chromosulfuric acid etching agent so that the plastic surface is roughened. The etching operation is followed by the relevant rinse step. Optionally, a neutralization step can be connected with the relevant rinse steps.

After the etching or the neutralization and the relevant rinse steps, the plastic part to be metallized is immersed in a solution in order to prepare the surface before the actual activation and, so to speak, to preactivate it. For this, the workpiece is immersed in a solution that contains 5-10 g/L KMnO₄, 0.01-0.1 g/L of a perfluorinated or partially fluorinated wetting agent (e.g., tetrafluorammonium perfluoroctanesulfonate, fluoralcylquaternaryammoniumchloride, fluoroaliphatic polymer esters) and 5-15 g/L sodium tetraborate. The temperature of the solution is 30-50° C. The solution is made to flow around the workpiece, which is achieved either by moving the bath and/or by moving the workpiece. The plastic part to be metallized is immersed in the solution for 4-6 min, but longer immersion times (up to 10-15 min) are not harmful and do not lead to any disadvantageous damage to the plastic surface.

The actual activation follows the preactivation by the solution described above and the obligatory rinse steps. This can be done by the activation methods that are known from the prior art and that are listed here only as a matter of example. For instance, the surface that has been pretreated and chemically modified by the solution can be activated with noble metal activators or with the metal complexes described above. In accordance with the embodiment example, the workpiece to be metallized is immersed for a period of 10 min in an ammoniacal solution that contains 0.1 mol/L COSO₄ and has a pH of 10 and a temperature of about 20° C. Then the plastic parts to be metallized are treated with water, which has been made alkaline to a pH of 13 with an alkali like NaOH. This is followed by treatment with a sulfide solution that contains 0.01 mol/L Na₂S₂. After the activation, the treated plastic surface is brought into contact with a reducing solution of the kind described above. For this, the plastic surface to be metallized is immersed in an aqueous solution having a hypophosphite content of 25 g/L. The reduction is followed by a direct electrolytic deposition of copper from an acid electrolyte such as Cuprostar 1530 (available from Enthone, Inc. of West Haven, Conn.).

### EXAMPLE 2

ABS/PC Blend (85% PC)

The plastic surface to be metallized is treated with a classic chromosulfuric acid etching agent so that the plastic surface becomes roughened. The etching operation is followed by the relevant rinse steps. Optionally, a neutralization step can also be connected with the relevant rinse steps.

After the etching or the neutralization and relevant rinse steps the plastic part to be metallized is immersed in a solution in order to prepare the surface before the actual activation and, as it were, to preactivate it. For this the workpiece is immersed in a solution that contains 5-10 g/L KMnO₄, 0.01-0.1 g/L of a perfluorinated or partially fluorinated wetting agent, and 5-15 g/L potassium dihydrogen phosphate. The temperature of the solution is 30-50° C. The solution is made to flow around the workpiece, which is achieved either by moving the bath and/or by moving the workpiece. The plastic to be metallized is immersed in a solution for 4-6 min, but longer immersion times (up to 10-15 min) are also harmless and do not lead to any disadvantageous damage to the plastic surface.

The preactivation by the solution described above and the obligatory rinse steps are followed by the actual activation. This can take place by the activation methods that are known from the prior art and that are listed here only as a matter of example. Thus, the surface that has been pretreated and chemically modified by the solution can be activated with noble metal activators or with the metal complexes that were described above. According to the embodiment example, the workpiece to be metallized is immersed for a period of 5 min in a Pd/Sn colloid-containing solution that contains 200-250 mg/L palladium, 10 g/L tin(II) and 110 g/L HCl and that has a temperature of about 40° C. Then the plastics that are to be metallized are rinsed and immersed for about 4 min in a solution that contains in each case 10 g/L of a thiosulfur compound and a hydroxycarboxylic acid and that has a temperature of about 55° C. After that the metal sulfide complexes on the surface of the workpieces to be metallized are electrolytically reduced in a sodium sulfate solution that has been adjusted to a pH of 5 with sulfuric acid, and copper is directly deposited from an acid electrolyte on the surface that is to be metallized.

### EXAMPLE 3

ABS/PC Blend (85% PC)

The plastic-surfaces to be metallized are etched in a 1000 g/L sulfuric acid that contains 30 g chromic acid. After the etching step the surfaces are brought into contact with an aqueous solution that contains bismuth methane sulfonates (10 g/L Bi) and whose pH value has been adjusted to under 1 by means of methanesulfonic acid, for 2 min at 25° C. After this treatment step the treated plastic surface is brought into contact with a 0.01 mol/L Na₂S₂ solution for 1 min in order to form bismuth sulfides on the surface. The bismuth sulfides that are formed after this treatment step are electrolytically reduced to metallic bismuth as described in Example 2. An adherent copper layer can be directly deposited onto the thus treated plastic surfaces from an acid copper electrolyte of the known kind.

As an alternative to electrolytic reduction, the bismuth sulfides formed on the surface can be chemically reduced to metal by means of dimethylaminoborane under the conditions described in Example 1.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above methods and products without departing from the scope of the invention, it is intended that all matter contained in the above description and shown in any accompanying drawings shall be interpreted as illustrative and not in a limiting sense.

1. A method for metallizing a plastic surface of a substrate comprising:
contacting the surface with a source of activator metal comprising an activator metal;
contacting the surface with a sulfide solution to form metallic sulfides of the activator metal on the surface;
reducing a quantity of the metallic sulfides on the surface from metallic sulfides to electrically conductive metal; and
metallizing the surface in a metallizing bath to deposit metal over the electrically conductive metal reduced from the metal sulfides.

2. The method of claim 1 wherein the activator metal is selected from the group consisting of cobalt, silver, tin, lead, bismuth, palladium, copper, nickel, gold, manganese, zinc, iron, and combinations thereof.

3. The method of claim 1 wherein the activator metal is a non-noble metal.

4. The method of claim 1 wherein said reducing comprises contacting the surface with a chemical reducing agent.

5. The method of claim 1 wherein said reducing comprises contacting the surface with a chemical reducing agent selected from the group consisting of sodium hypophosphite, dimethylaminoborane, hydrazines, hydrazine hydrate, hydroxyammonium sulfate, sulfites, formates, and combinations thereof.

6. The method of claim 1 wherein said reducing comprises electrochemically reducing the metallic sulfides by application of an external source of electrons via an electrolyte.

7. The method of claim 1 wherein said reducing comprises electrochemically reducing the metallic sulfides by application of an external source of electrons via a sodium sulfate solution electrolyte having a pH in the range of about 1 to about 7.

8. The method of claim 1 wherein the sulfide solution comprises a sulfide compound selected from the group consisting of sodium sulfide, ammonium sulfide, ammonium polysulfide, or combinations thereof.

9. The method of claim 1 further comprising etching the plastic surface prior to said contacting the plastic surface with the source of activator metal.

10. The method of claim 9 wherein said etching comprises contacting the surface with an acid aqueous etching solution that contains a compound selected from the group consisting of permanganate, phosphoric acid, methanesulfonic acid, chromic acid, sulfuric acid, and combinations thereof.

11. The method of claim 9 wherein said etching comprises contacting the surface with an aqueous, alkaline, permanganate-containing etching solution.

12. The method of claim 1 wherein metallic sulfides are complexes having a size between about 0.5 and about 500 nanometers.

13. The method of claim 2 wherein said reducing comprises contacting the surface with a chemical reducing agent.

14. The method of claim 2 wherein said reducing comprises contacting the surface with a chemical reducing agent selected from the group consisting of sodium hypophosphite, dimethylaminoborane, hydrazines, hydrazine hydrate, hydroxyammonium sulfate, sulfites, formates, and combinations thereof.

15. The method of claim 2 wherein said reducing comprises electrochemically reducing the metallic sulfides by application of an external source of electrons via an electrolyte.

16. The method of claim 2 wherein said reducing comprises electrochemically reducing the metallic sulfides by application of an external source of electrons via a sodium sulfate solution electrolyte having a pH in the range of about 1 to about 7.

17. The method of claim 2 wherein the sulfide solution comprises a sulfide compound selected from the group consisting of sodium sulfide, ammonium sulfide, ammonium polysulfide, or combinations thereof.

18. The method of claim 2 further comprising etching the plastic surface prior to said contacting the plastic surface with the source of activator metal.

19. The method of claim 18 wherein said etching comprises contacting the surface with an acid aqueous etching solution that contains a compound selected from the group consisting of permanganate, phosphoric acid, methanesulfonic acid, chromic acid, sulfuric acid, and combinations thereof.

20. The method of claim 18 wherein said etching comprises contacting the surface with an aqueous, alkaline, permanganate-containing etching solution.

21. The method of claim 2 wherein the metallic sulfides are complexes having a size between about 0.5 and about 500 nanometers.

22. The method of claim 1 wherein the activator metal is bismuth.

23. A method for metallizing a plastic surface of a substrate comprising, in order:
etching the plastic surface;
rinsing the plastic surface;
contacting the surface with a source of activator metal comprising an activator metal selected from the group consisting of cobalt, silver, tin, lead, bismuth, palladium, copper, nickel, gold, manganese, zinc, iron, and combinations thereof;
contacting the surface with a sulfide solution to form metallic sulfides of the activator metal on the surface;
reducing a quantity of the metallic sulfides on the surface from metallic sulfides to electrically conductive metal; and
metallizing the surface in a metallizing bath to deposit metal over the electrically conductive metal reduced from the metal sulfides.
